(19) United States
(12) Patent Application Publication
(10) Pub. No.: US 2016/0134543 A1
(43) Pub. Date: May 12, 2016

(54) METHOD AND ASSOCIATED NETWORK DEVICE FOR MANAGING NETWORK TRAFFIC

(71) Applicant: MediaTek Singapore Pte. Ltd., Singapore (SG)

(72) Inventors: Ming Zhang, San Jose, CA (US); Jonathan Chang, Cupertino, CA (US)

(21) Appl. No.: 14/534,266

(22) Filed: Nov. 6, 2014

(51) Int. Cl. H04L 12/803

(52) U.S. Cl. CPC H04L 47/125

(57) ABSTRACT

A method and associated network device for managing network traffic by selecting one of multiple equal-cost paths for a packet of a flow is provided. The method comprises: selecting one of path sequences for the packet, each path sequence being an orderly list, e.g., an evenly randomized permutation, of multiple tokens respectively associated with the paths; marking each token as valid or invalid according to whether the associated path is active; and selecting one of the paths according to an order of the tokens in the selected path sequence.

### FIELD OF THE INVENTION

The invention relates to a method and associated network device for managing network traffic, and more particularly, to a method and associated network device for resilient routing over multiple equal-cost paths.

### BACKGROUND OF THE INVENTION

Computer/communication network for exchanging information has become essential for modern information society. Network is established over plural network nodes, such as terminals, servers, databases, bridges, switches, and routers, etc. Network traffic information, e.g., information traveling in the network, is carried by packets. For a first network node which owns multiple paths, e.g., network egress interfaces and/or ports, capable of reaching a same second node, traffic from the first network node to the second network node can be split into different flows by assigning each packet of the network traffic to one of the flows, so the packets are forwarded to the second network node via the multiple paths.

While applying the aforementioned multipath routing from the first network node to the second network node, it is important to develop a path selection mechanism for the first network node to systematically determine how to select a path for each flow. It should be noted that number of active paths (paths usable to bear flows of the network traffic) is varying with time. Whenever the number of active paths changes, the path selection mechanism is impacted because it has to reassign paths for some of flows. For example, if a first path originally being active turns to be inactive, flows originally planned to be forwarded by the first path are disrupted, and the path selection mechanism needs to select other active path(s) to forward these disrupted flows. On the other hand, if a second path originally being inactive turns to be active, some of the flows originally to be forwarded by other active paths can be forwarded by the second path for maximum multipath efficiency, and the path selection mechanism needs to determine which flows should be disrupted to be reassigned to the second path.

A path selection mechanism is preferred to be resilient to reduce or minimize quantity of disrupted flows (e.g., flows required to be reassigned) when the number of active paths changes. However, known prior art path selection mechanisms, such as modulo based hash-threshold path selection, fail to be resilient.

### SUMMARY OF THE INVENTION

An objective of the invention is providing a method for managing a network traffic by selecting one of a plurality of paths for a packet of the network traffic. The method may be applied to a network device which implements a network node. The method may comprise:

categorizing the packet to one of a plurality of group indices by, e.g., calculating a calculation index for the packet according to content of the packet, and categorizing the packet to the group index that is equal to the calculation index of the packet; wherein the group indices may be respectively associated with a plurality of path sequences, each of the path sequences may be an orderly list of a same plurality of tokens, and the tokens may respectively be associated with the paths;

when one of the paths is in a first status (e.g., is active and capable of bearing the network traffic), marking the token associated with the active path as valid; and, when one of the paths is in a second status (e.g., is inactive and incapable of bearing the network traffic), marking the token associated with the inactive path as invalid;

selecting one of the path sequences for the packet; for example, selecting the path sequence that is associated with the categorized group index of the packet; and

according to an order of the tokens in the selected path sequence, selecting one of the paths for the packet.

While categorizing the packet to one of the group indices, the packet may be so categorized that the packet has statistically equal probability to be categorized to any one of the group indices. Also, each token has statistically equal probability to be listed in any order of any one of the path sequences. Preferably, permute order of the tokens to provide the path sequences, such that each of the path sequences reflects a permutation of the tokens.

An objective of the invention is providing a network device capable of controlling or implementing a network node with multiple paths. The network device may comprise an access block, a validness block, a permutation block and a path selection block. The access block may be responsible for controlling the paths for cooperatively bearing a network traffic.

The permutation block may be responsible for providing a plurality of permutations formed by permuting order of a plurality of tokens, wherein the tokens may be respectively associated with the paths.

The validness block may be responsible for:

when one of the paths is in a first status (e.g., is active and capable of bearing the network traffic), marking the token associated with the active path as valid; and

when one of the paths is in a second status (e.g., is inactive and incapable of bearing the network traffic), marking the token associated with the inactive path as invalid. For example, the validness block may set a validness signal for each of the tokens, so as to record whether each token is marked as valid or invalid.

For a packet of the network traffic, the path selection block may be responsible for:

categorizing the packet to one of a plurality of group indices by, e.g., calculating a calculation index for the packet according to content of the packet, and categorizing the packet to the group index that is equal to the calculation index; wherein the group indices may be respectively associated with the permutations;

selecting one of the paths for the packet according to one of a plurality of path sequences, wherein each path sequence may represent one of the permutations.

For example, the path selection block may select according to the path sequence which represents the permutation that is associated with the categorized group index of the packet. According to an order of the tokens in the path sequence, the path selection block may select the path that is associated with the highest ordered token (among the valid tokens) in the path sequence.

While the path selection block works, the packet may be so categorized that the packet has statistically equal probability to be categorized to any one of the group indices. Also, each of the tokens has statistically equal probability to be listed in any order of any one of the permutations.

Numerous objects, features and advantages of the invention will be readily apparent upon a reading of the following detailed description of embodiments of the invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the invention will become more readily apparent to those ordinarily skilled in the art after reviewing the following detailed description and accompanying drawings, in which:

FIG. 1 exemplarily illustrates a simple network or a simplified part of a network;

FIG. 2 illustrates a flowchart according to an embodiment of the invention;

FIG. 3 illustrates a network device according to an embodiment of the invention;

FIG. 4 to FIG. 6 illustrate disruption handling in different scenarios according to an embodiment of the invention; and

FIG. 7 to FIG. 8 illustrate disruption handling in different scenarios according to an embodiment of the invention.

### DETAILED DESCRIPTION OF PREFERRED EMBODIMENTS

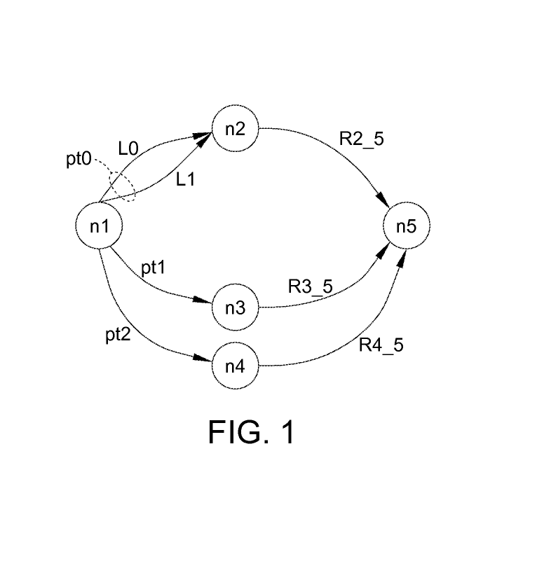

Please refer to FIG. 1 exemplarily illustrating a simple network or a simplified part of a network, including network nodes n1, n2, n3, n4 and n5, along with a path pt0 between the network node n1 and n2, a path pt1 between the network nodes n1 and n3, a path pt2 between the network nodes n1 and n4, a path R2_5 between the network nodes n2 and n5, a path R3_5 between the network nodes n3 and n5, as well as a path R4_5 between the network nodes n4 and n5. As shown in FIG. 1, the network node n1 has three paths pt0 to pt2. Each of the paths pt0 to pt2 may be a physical port, a logic port, or a LAG (link aggregation group). For example, the path pt0 may include two links L0 and L1; the links L0 and L1 both connect between the network nodes n1 and n2, and therefore may be aggregated according to LAG to form the path pt0.

Assuming that the network node n1 has to forward a network traffic to the network node n5, then there are three routes which may be utilized to bear the network traffic: a first route is via the paths pt0 and R2_5 from the network nodes n1, n2 to n5; a second route is via the paths pt1 and R3_5 from the network nodes n1, n3 to n5; a third route is via the paths pt2 and R4_5 from the network nodes n1, n4 to n5. Cost of each route may be evaluated; if the three routes are of equal costs, then the network node n1 has three equal-cost paths pt0, pt1 and pt2 to share the total network traffic toward the network node n5. The paths pt0, pt1 and pt2 respectively connecting to different network nodes n2, n3 and n4 may be jointly leveraged according to ECMP (equal cost multipath).

To make full advantages of the multiple paths (pt0 to pt2 in this example) to share the network traffic toward the node n5, the network node n1 may split the network traffic to a plurality of flows by dispatching each packet of the network traffic to one of the flows, each flow may therefore be formed collectively by a plurality sequential packets. Hence, the network node n1 may forward the flows to the network n5 via the multiple paths.

However, number of paths available to share the network traffic is subject to temporal fluctuation. For example, if the network node n4 is down (e.g., due to malfunction or normal powering down, etc.), then the path pt2 becomes inactive, and no longer available to forward flows. Flows originally planned to be forwarded via the path pt2 are thus disrupted, and have to be reassigned to other active path(s). If the network node n4 is back on line later, then the path pt2 turns to be active, and available to forward flows. Some flows originally not planned to be forwarded via the path pt2 are thus disrupted, because these flows are reassigned to the path pt2 for rebalance of traffic sharing.

Therefore, the network node n1 needs a path selection mechanism, not only to select one of the multiple paths for each flow, but also to overcome variation in number of active paths by reducing number of disrupted flows when the number of active paths varies. Regarding reduction of disruption, a reference goal for a preferable path selection mechanism may be: limiting disrupted (reassigned) flows to 1/N of total flows, when a number N of active paths increments or decrements by 1. That is, a resilient path selection mechanism is expected to keep number of disrupted flows (approximately) less than or equal to 1/N of total flows, when number of active paths increments or decrements by 1 from N.

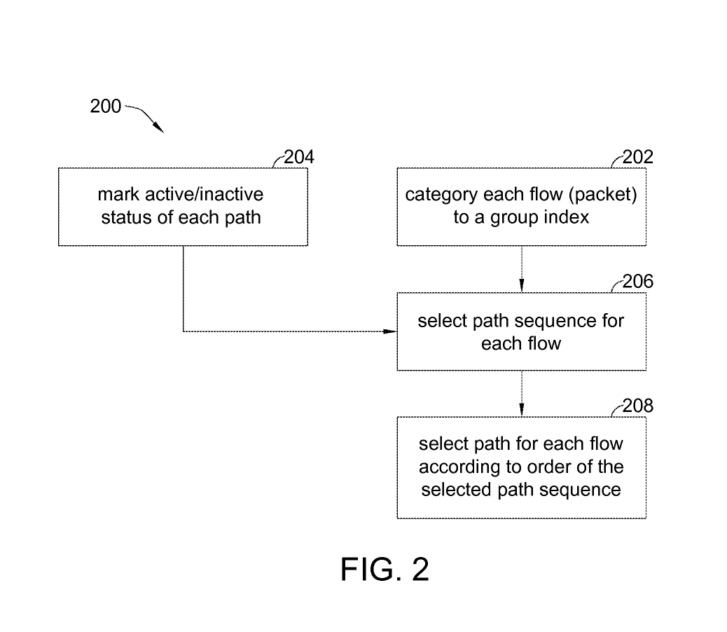

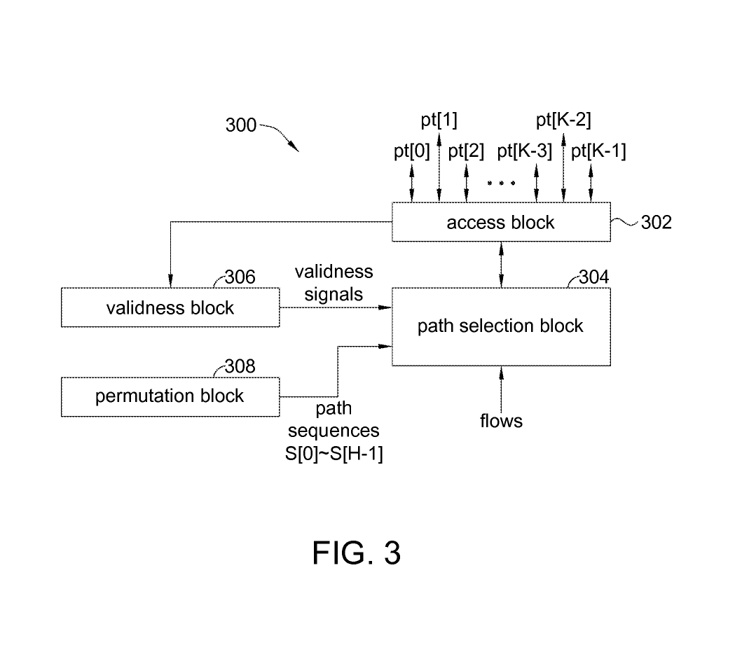

Please refer to FIG. 2 and FIG. 3. FIG. 2 illustrates a flowchart 200 according to an embodiment of the invention, and FIG. 3 illustrates a network device 300 capable of implementing the flowchart 200. By following the flowchart 200, the network device 300 shown in FIG. 3, which owns or controls a number K of multiple paths (e.g., equal-cost paths) pt[0] to pt[K−1] to share a network traffic, may implement a path selection mechanism with preferable reduction of disruption. The network device 300 may be a network node (e.g., a terminal, a server, a database, a network bridge, a network switch, a hub, a router, etc.), or a portion (e.g., a controller, a processor, a chip, an integrated circuit, etc.) of a network node. The network device 300 may include an access block 302, a path selection block 304, a validness block 306 and a permutation block 308. Major steps of the flowchart 200 may be described as follows.

Step 202 (FIG. 2): categorize each flow (and therefore each packet) of the network traffic to one of a plurality of predetermined group indices. To start the flowchart 200 for sharing the network traffic over multiple paths, the network traffic may first be split to flows, then all the flows may be further categorized to group indices, so all the flows may be divided to different (mutually exclusive) subsets, wherein each subset is associated with a group index, and may include one or multiple flows.

For example, a first subset (including one or more flows) of all the flows may be categorized to a first group index (e.g., 0), a second subset of all the flows, including one or more flows other than the flow(s) in the first subset, may be categorized to a second group index (e.g., 1), and so on.

Network traffic splitting and flow categorization may take place at packet level. For each packet, tuples may be extracted (e.g., from predetermined header fields of each packet), and packets with same tuples may be grouped to a same flow, hence the network traffic may be split to flows. Furthermore, for each packet, a hash value may be calculated according to a preselected subset of the tuples of each packet, and a calculation index may be calculated based on the hash value, e.g., by extracting a part of the hash of each packet; thus, packets with equal calculation indices may be categorized to a same group index. That is, the calculation index of each packet may serve as a group index to categorize each packet.

Equivalently, categorizing each packet to an associated group index may include: calculating a calculation index for each packet according to content of each packet, and categorizing each packet to a group index equal to the calculation index.

In an embodiment, each group index may be an m-bit binary value (with m being a predetermined integer), so there may be 2̂m different group indices. These group indices may be respectively associated with same quantity of path sequences, each path sequence may be an orderly list of multiple tokens, which may respectively be associated with the multiple paths. For example, each path sequence may include or reflect a permutation of the multiple tokens, such that there may be at least two path sequences in which the multiple tokens are listed in different orders. Furthermore, a validness signal may be provided for each token.

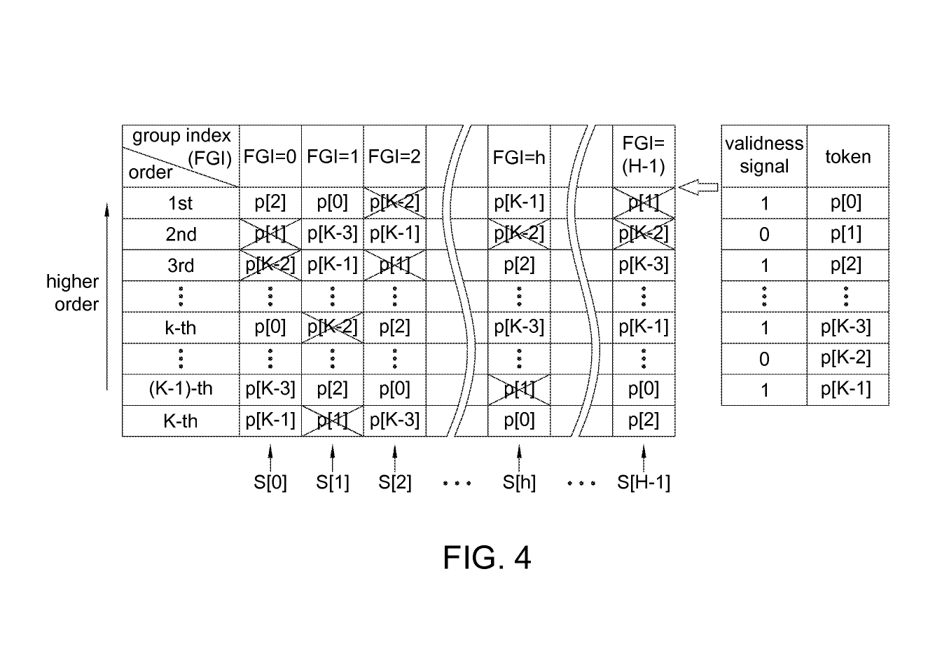

Along with FIG. 2 and FIG. 3, please refer to FIG. 4 illustrating exemplary path sequences according to an embodiment of the invention. In the example of FIG. 4, there may be a number H of different group indices (also denoted as FGI, flow group index), and therefore number H of subsets, to be shared by number K of paths pt[0] to pt[K−1] (FIG. 3). For example, the group indices may range from 0 to (H−1), wherein the number H may equal to 2̂m, if each group index is an m-bit binary value.

Each group index h (for h=0 to (H−1)) may be associated with a path sequence S[h], and each path sequence S[h] may be a permutation of a number K of tokens p[0], p[1], p[2], p[3], . . . , p[K−3], p[K−2] and p[K−1]. In other words, each path sequence may be formed by permuting order of the tokens p[0] to p[K−1]. For example, as shown in the example of FIG. 4, the path sequence S[0] associated with a group index equal to 0 (i.e., FGI=0) may have p[2], p[1], p[K−2], . . . , p[0], . . . , p[K−3] and p[K−1] respectively in the first, second, third, k−th, (K−1)-th and K-th order, while the path sequence S[1] associated with a group index equal to 1 (i.e., FGI=1) may have p[0], p[K−3], p[K−1], . . . , p[K−2], . . . , p[2] and p[1] respectively in the first, second, third, k-th, (K−1)-th and K-th order.

The numbers K and H do not have to be equal. For example, the number H may be greater than the number K, and/or be a multiple of K, e.g., H=Q*K with Q greater than 1 (e.g., greater than 5). Each token p[k] (for k=0 to (K−1)) may represent a path pt[k] of the K multiple paths pt[0] to pt[K−1] (FIG. 3). In addition, as shown at right of FIG. 4, each token p[k] may also be accompanied with a validness signal. For example, the accompanying validness signal is a 1-bit flag.

Step 204 (FIG. 2): mark active/inactive status of each path. Following the example in FIG. 4, active/inactive status of a path pt[k] may be recorded by the validness signal accompanying the token p[k]. For example, when a path pt[k1] is active and capable of bearing the network traffic, the associated token p[k1] may be marked as valid by setting the accompanying validness signal to a first value, such as 1. On the other hand, when a path pt[k2] is inactive and incapable of bearing the network traffic, the associated token p[k2] may be marked as invalid by setting the accompanying valid signal to a second value, such as 0.

In the example of FIG. 4, the paths pt[1] and pt[K−2] (FIG. 3) associated with the tokens p[1] and p[K−2] are inactive, hence the validness signals accompanying the tokens p[1] and p[K−2] may be set to 0 to mark them as invalid. For comprehensive understanding of the embodiment, in FIG. 4, the invalid tokens p[1] and p[K−2] in each of the path sequence S[0] to S[H−1] are overlaid with an “x” sign, to denote that the tokens p[1] and p[K−2] are invalid. Other paths are active, hence their accompanying validness signals may be set to 1 to mark them as valid.

The network device 300 adopting the flowchart 200 may regularly (e.g., periodically) check active/inactive statuses of the paths pt[0] to pt[K−1], e.g., by polling, and instantly reflect the statuses by setting the accompanying validness signals; and/or, the network device 300 may be informed about the statuses of the paths.

Step 206 (FIG. 2): select a path sequence for each flow. For example, select the path sequence that is associated with the categorized group index of each flow. Following the example shown in FIG. 4, if a flow is categorized to a group index equal to h, then the path sequence S[h] may be selected.

Step 208 (FIG. 2): according to an order of the tokens in the selected path sequence, select a path for each flow, so each flow may be forwarded via the selected path. In an embodiment, step 208 may be performed by selecting the path that is associated with the highest ordered token among the valid tokens in the selected path sequence of each flow.

Following the example shown in FIG. 4, if a flow is categorized to a group index equal to 0, then the path sequence S[0] may be selected for the flow in step 206, and the path pt[2] (FIG. 3) associated with the token p[2] may be selected for the flow in step 208, because the token p[2] is of the highest order among the valid tokens in the path sequence S[0].

For a flow which is categorized to a group index equal to 2, the path sequence S[2] may be selected in step 206, and the path pt[K−1] associated with the token p[K−1] may be selected in step 208 to forward the flow, because the token p[K−1] is of the highest order among the valid tokens in the path sequence S[2]. In the path sequence S[2], though the token p[K−2] occupies the first order, but it is marked as invalid, so the highest ordered valid token is the token p[K−1].

For a flow which is categorized to a group index equal to (H−1), the path sequence S[H−1] may be selected in step 206, and the path pt[K−3] associated with the token p[K−3] may be selected in step 208, because the token p[K−3] is the highest ordered valid token in the path sequence S[H−1]. In the path sequence S[H−1], though the tokens p[1] and p[K−2] are listed in the first order and second order, but they are marked as invalid, so the third ordered token p[K−3] becomes the highest ordered valid token.

In other words, during step 206, the token(s) associated with inactive path(s) and therefore marked as invalid may be ignored, and order of the rest valid token(s) in a path sequence is referenced for selecting a path for a flow which is categorized to be associated with the path sequence. The flowchart 200 according to the invention may accordingly dynamically adapt difference scenarios when number of active paths changes.

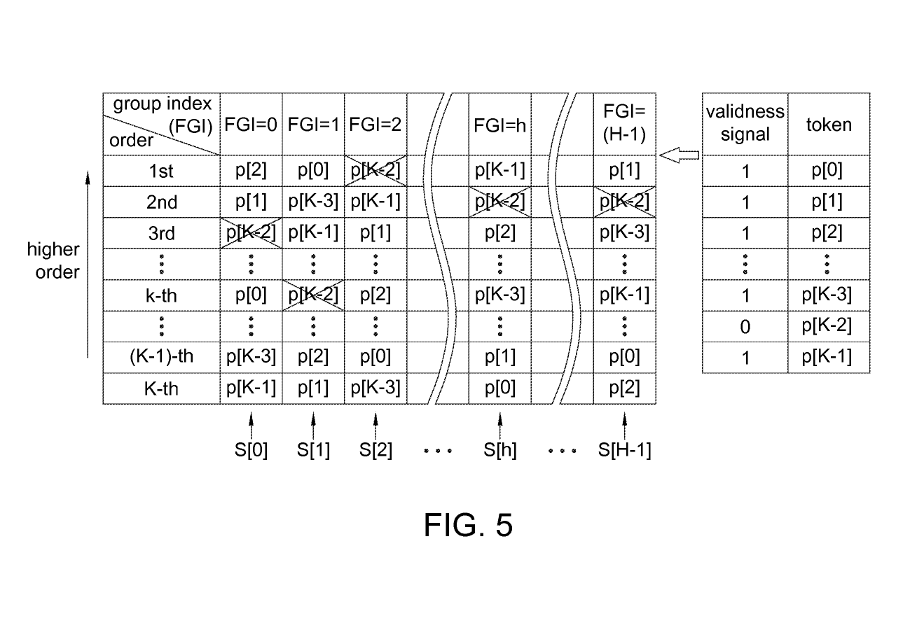

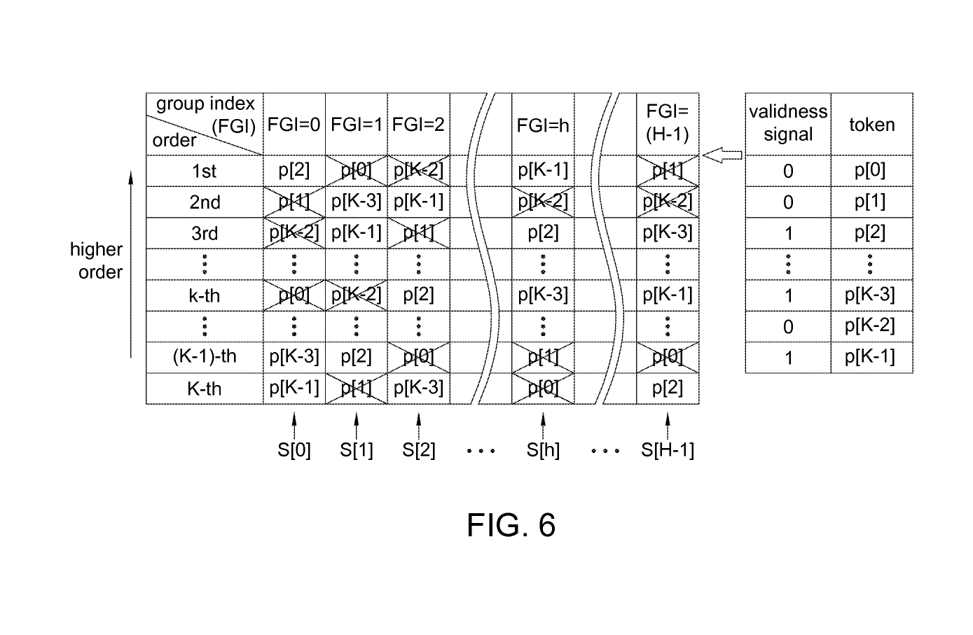

Continuing FIG. 4 which illustrates a scenario with two inactive paths and therefore two invalid tokens in each path sequence, please refer to FIG. 5 and FIG. 6. FIG. 5 illustrates a scenario when number of inactive paths changes to one, and FIG. 6 illustrates a scenario when number of inactive paths is three.

In the example of FIG. 5, the path pt[1] (FIG. 3) associated with the token p[1] is originally inactive in FIG. 4, but turns to be active in FIG. 5. The validness signal accompanying the token p[1] is therefore set to 1 to mark the token p[1] as valid in each path sequence. For flows categorized to group indices equal to, e.g., 0 and 2, the path sequence S[0] and S[2] may be selected in step 206, and the paths pt[2] and pt[K−1] respectively associated with the tokens p[2] and p[K−1] may be selected in step 208. That is, for flows categorized to group indices 0 and 2, results of path selection in the scenario shown in FIG. 5 are the same as those in the scenario shown in FIG. 4; these flows therefore remain not disrupted when the scenario in FIG. 4 changes to the scenario in FIG. 5.

On the other hand, for flows categorized to the group index (H−1), the highest ordered valid token in the path sequence S[H−1] changes from the token p[K−3] to the token p[1] when scenario changes from FIG. 4 to FIG. 5. Thus, the flows categorized to the group index (H−1) are disrupted when scenario transits from FIG. 4 to FIG. 5; these flows are originally assigned to the path pt[K−3] in FIG. 4, but are reassigned to the path pt[1] associated the token p[1] in FIG. 5.

In the example of FIG. 6, the path pt[0] associated with the token p[0] is originally active in FIG. 4, but turns to be inactive in FIG. 6. The validness signal accompanying the token p[0] is accordingly set to 0 to mark the token p[0] as invalid. If the scenario changes from FIG. 4 to FIG. 6, flows categorized to the flow index (H−1) are not disrupted, because the token p[K−3] is still the highest ordered valid token in the path sequence S[H−1]. However, flows categorized to the flow index 1 are disrupted, because the highest ordered valid token changes from the token p[0] to the token p[K−3].

Though “highest ordered valid token” in a path sequence is referenced to select path in aforementioned embodiment, the invention is not limited to such selection. For example, step 208 may work by selecting the path associated with the “second highest ordered valid token” in a path sequence, or even “the lowest ordered valid token” in a path sequence. That is, step 208 may work by selecting a path associated with a token of a predetermined relative (e.g., the highest, the second highest or the lowest, etc.) order among the valid tokens in a path sequence.

While categorizing each flow/packet to a group index in step 202, the categorization may be arranged to allow each flow having substantially statistically equal probability to be categorized to any one of all the different group indices, so the subset associated with each group index may include approximately same number of flows (and packets).

While providing the path sequences S[0] to S[H−1], the tokens p[0] to p[K−1] may be uniformly distributed over each order of each path sequence. That is, each token p[k] may have substantially statistically equal probability to be listed in any order of any path sequence S[h]. For example, each path sequence S[h] may be generated by randomly permuting order of the tokens p[1] to p[K−1]. For example, the permuting may be randomized based on Knuth permutation algorithm. That is, the H path sequences S[0] to S[H−1] may be regarded as results of randomly shuffling the tokens p[0] to p[K−1] for H times.

The path sequences S[0] to S[H−1] may be pre-computed and stored in a table before the flowchart 200 starts, so the network device may access the table for the path sequences during execution of the flowchart 200. Alternatively, the path sequences S[0] to S[H−1] may be computed on-the-fly, during execution of the flowchart 200. For example, step 202 may further include: permuting order of the tokens p[0] to p[K−1] to provide the path sequences S[0] to S[H−1], such that each path sequence S[h] reflects a permutation of the tokens p[0] to p[K−1].

Uniform categorization in step 202 and uniform permutation of the path sequences not only may help to evenly distribute flows over paths, but also may help to reduce disrupted flows when number of active paths changes, such that disrupted flows may approximately be 1/N of total flows, when a number N of active paths increments or decrements by 1. Permuting K total tokens randomly and ignoring (K−N) invalid tokens are substantially statistically equivalent to randomly shuffling N valid tokens. Accordingly, any one of N valid tokens has 1/N probability to be the highest ordered (or a predetermined ordered) valid token over the H path sequences. As a result, any one of the N active paths is statistically responsible for H/N subsets over total H subsets of flows, and the path selection mechanism according to the invention can uniformly distribute the network traffic over active paths.

In addition, because an active path pt[k] is statistically responsible for H/N subsets, if the active path pt[k] becomes inactive, only the flows originally assigned to the active path pt[k] need to be disrupted and reassigned, hence H/N subsets out of total H subsets are disrupted, resulting 1/N (1/N=(H/N)/H) of disrupted flows over all flows. Therefore, the path selection mechanism according to the invention can effectively reduce ratio of disrupted flow.

In the network device 300 shown in FIG. 3, the access block 302 may be responsible for controlling the paths pt[0] to pt[K−1] to cooperatively bearing a network traffic. The permutation block 308 may be responsible for providing number H of permutations formed by permuting order of the tokens p[0] to p[K−1] (FIG. 4) respectively associated with the paths pt[0] to pt[K−1]. The number H of permutations may be respectively associated with the number H of group indices 0 to (H−1) (FIG. 4), and be included in the number H of path sequences S[0] to S[H−1]. In an embodiment, the permutation block 308 may be a hardware for randomly permuting the tokens p[0] to p[K−1] on-the-fly based on Knuth permutation algorithm. Alternatively, the permutation block 308 may be a memory, or a circuit for accessing a memory, which stores pre-computed permutations as the path sequences S[0] to S[H−1].

Note that data structure of the path sequences S[0] to S[H−1] may maintain the same even when the number of active paths varies, because active/inactive statuses of the paths may be marked by the validness signals. Hence, the path selection according to the invention may handle disruption (e.g., adapt variation in number of active paths) efficiently by simply asserting or de-asserting the validness signals accompanying the paths. On the contrary, when number of active paths varies, prior art path selection mechanisms need to reconstruct mapping table(s) utilized to assign flows to the updated active paths, and hence suffer degraded efficiency to adapt variation in number of active paths.

The validness block 306 may implement step 204 (FIG. 2) to set the validness signal accompanying each of the tokens p[0] to p[K−1]. When a path, e.g., pt[k_a], is active and capable of bearing the network traffic, the validness block 306 may mark the associated token p[k_a] as valid. When a path, e.g., pt[k_i], is inactive, the validness block 306 may mark the associated token p[k_i] as invalid.

The path selection block 304 may implement steps 206 and 208. For a packet in a flow, the path selection block 304 may categorize the flow (and therefore the packet) to a group index h (e.g., one of 0 to (H−1)) by, e.g., calculating a calculation index for the packet according to content (e.g., hash) of the packet, and categorizing the packet to the group index that is equal to the calculation index. The path selection block 304 may also provide a path sequence S[h] (by selecting one of the path sequences S[0] to S[H−1]) for the packet, wherein the path sequence S[h] may include the permutation that is associated with the categorized group index h of the packet. According to an order of the tokens p[0] to p[K−1] in the path sequence S[h], the path selection block 304 may select a path for the flow (and therefore the packet). For example, select the path that is associated with the highest ordered valid token in the path sequence S[h]. For example, the path selection block 304 may further access an ECMP table (not shown in FIG. 3) for operation information (not shown) of each path. The ECMP table may include entries respectively recording operation information of the paths pt[0] to pt[K−1]. By utilizing reference parameters such as a start location of the first entry and a count indicating number of consecutive entries after the first entry, the path selection block 304 may obtain entries for active paths, and then control the access block 302 to perform flow forwarding as planned by the path selection mechanism.

One, some or all of he blocks of the network device 300 may be implemented by hardware, or by a processor executing related software or firmware.

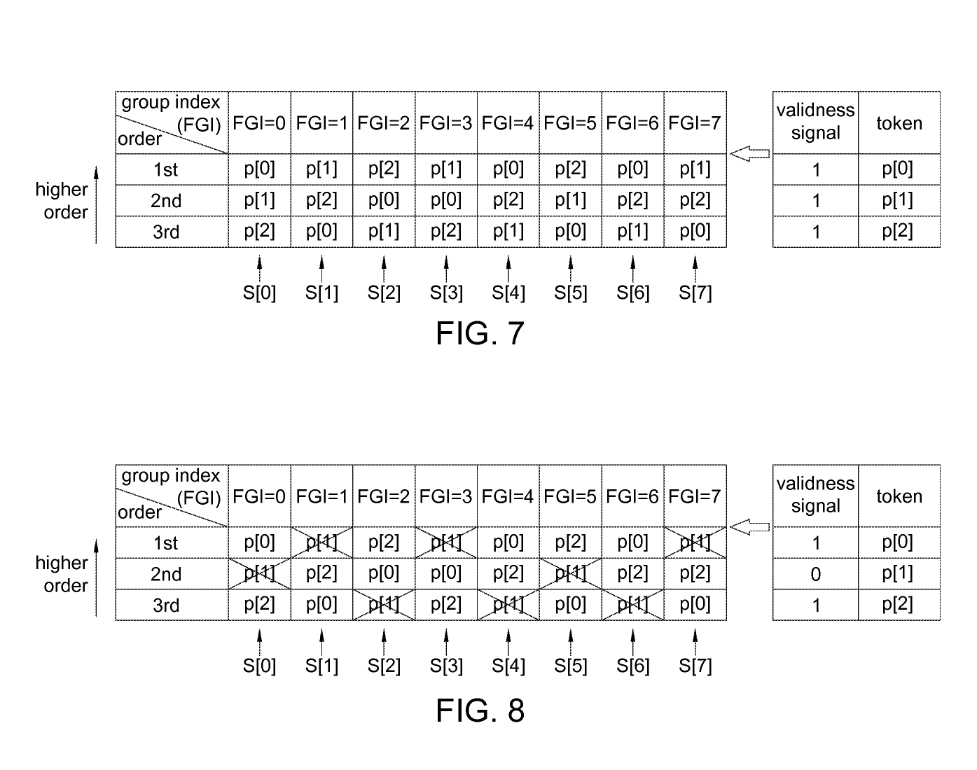

Operation and effectiveness of the flowchart 200 and the network device 300 may also be understood by referring to FIG. 7 and FIG. 8 respectively illustrating a path selection in two scenarios when number of active paths varies. The path selection in FIG. 7 and FIG. 8 is applied to a network device sharing network traffic by multiple paths pt[0], pt[1] and pt[2] (not shown) respectively represented by tokens p[0], p[1] and p[2], i.e., K=3. Each group index is a 3-bit binary value, so there are eight (i.e., H=2̂3=8) different group indices (ranging from 0 to 7) and associated eight path sequences S[0] to S[7].

In the first scenario shown in FIG. 7, all three paths are active with the validness signals accompanying the tokens p[0] to p[2] marking them as valid by 1. According to path selection in the flowchart 200 (FIG. 2), flows with a group index equal to 0, 4 or 6 are forwarded by the path pt[0] associated with the token p[0], since the token p[0] is the highest ordered valid token in the path sequences S[0], S[4] and S[6]. Flows with a group index equal to 1, 3 or 7 are forwarded by the path pt[1] associated with the token p[1], because the token p[1] is the highest ordered valid token in the path sequences S[1], S[3] and S[7]. Flows with a group index equal to 2 or 5 are forwarded by the path pt[2] associated with the token p[2], because the token p[2] is the highest ordered valid token in the path sequences S[2] and S[5].

In other words, while all the flows are categorized to eight subsets respectively associated with the eight different group indices, the path selection according to the invention is capable of substantially evenly averaging all the flows over the three paths, because the paths pt[0], pt[1] and pt[2] respectively associated with the tokens p[0], p[1] and p[2] forward three, three, and two subsets among all the eight subsets.

In the second scenario shown in FIG. 8, the originally active path pt[1] is down and inactive, thus the associated token p[1] is marked as invalid by 0. In the second scenario, flows with a group index equal to 0, 4 or 6 remain to be forwarded by the path pt[0], because the token p[0] is still the highest ordered valid token in the path sequences S[0], S[4] and S[6], similar to the first scenario shown in FIG. 7. However, flows with a group index equal to 3, which are originally forwarded by the path pt[1] associated with the token p[1] in the first scenario, are disrupted in the second scenario when number of active paths decrements from three to two, and are reassigned to the path pt[0] associated the token p[0] in the second scenario, since the token p[0] becomes the highest ordered valid token in the associated path sequence S[3].

In the second scenario, flows with a group index equal to 2 or 5 remain to be forwarded by the path pt[2], because the token p[2] is still the highest ordered valid token in the path sequences S[2] and S[5], similar to the first scenario shown in FIG. 7. However, flows with a group index equal to 1 and 7, which are originally forwarded by the path pt[1] associated with the tokens p[1] in the first scenario, are disrupted in the second scenario when number of active paths decrements from three to two, and are reassigned to the path pt[2] associated the token p[2] in the second scenario, since the token p[2] becomes the highest ordered valid token in the associated path sequences S[1] and S[7].

Accordingly, in the second scenario, all the flows are still evenly averaged over the active paths (only two now); among all the eight subsets of flows, four subsets (with group indices equal to 0, 3, 4 and 6) are forwarded by the active path pt[0], and another four subsets (with group indices equal to 1, 2, 5 and 7) are forwarded by the path pt[2]. As number of active paths changes from three to two, three subsets (with group indices equal to 1, 3 and 7) of flows are disrupted. That is, there are 3/8 of total flows disrupted; the ratio 3/8 closely approximates 1/3, i.e., the preferable disruption reduction goal 1/N, wherein the number N is number of active paths, which equals 3 in the example of FIG. 7 and FIG. 8.

On the other hand, if number of active paths resumes from the second scenario in FIG. 8 to the first scenario in FIG. 7, there are, again, 3/8 of total flows disrupted: two subsets with flow indices 1 and 7 originally assigned to the path pt[2] associated with the token p[2] in the second scenario are reassigned to the path pt[1] associated with the token p[1] in the first scenario, and one subset with flow index 3 assigned to the path pt[0] associated with the token p[0] in the second scenario are reassigned to the path pt[1] associated with the token p[1] in the first scenario.

In other words, the path selection mechanism according to the invention may effectively limit ratio of disrupted flows substantially close to 1/N, when number of active paths increments or decrements 1 from N. In known prior art path selection mechanisms, such as modulo based hash-threshold path selection, the ratio of disrupted flows ranges from 1/4 to 1/2, fails to further reduce as the number N of active path grows.

In FIG. 3, each of the paths pt[0] to pt[K−1] may be a logic port or a physical port. For example, in an embodiment implementing layer-3 (of OSI, open system interconnection) ECMP, each path may be a layer-3 logic path for next-hop forwarding, wherein a layer-3 logic path is utilized to derive a physical port, or a LAG. If the layer-3 logic path is utilized to derive a LAG, another level of path selection is performed to derive an equivalent physical port. For example, each path pt[k] (for k=0 to (K−1)) may include a number N_k of (equal-cost) links, different paths pt[k1] and pt[k2] may respectively be formed by different numbers N_k1 and N_k2 of links. In such embodiment, a first level of path selection (e.g., a layer-3 path selection) may be utilized to select one of the paths pt[0] to pt[K−1] for a flow; assuming that a path pt[k0] derived by a number of N_k0 links is selected for the flow, a second level of path selection (e.g., a layer-2 link selection) may be utilized to share packets of the flow over the N_k0 physical links of the path pt[k0] by selecting one of the N_k0 links to forward each packet of the flow. Either one or both of the first level path selection and the second level path selection may be implemented according to the flowchart 200.

When the flowchart 200 is adopted to implement the second level path selection (i.e., the layer-2 link selection) for assigning packets of a flow to N_k0 links of a selected path pt[N_k0], step 202 may categorize each packet of the flow to one of a number H_k0 of mutually exclusive subgroup of the flow, the path sequences in step 206 may be regarded as link sequences respectively including H_k0 permutations associated with the H_k0 subgroups, each permutation may be a randomly shuffle of N_k0 tokens respectively associated with the N_k0 links of the path pt[k0].

On the other hand, in an embodiment implementing TRILL (transparent interconnection of lots of links) ECMP, each path may be a physical port or an LGA, and the first level path selection and the second level path selection may be applied.

In general, the invention may provide a connection selection (path selection or link selection) mechanism for sharing network flux (a network traffic or a flow) over a number K of multiple connections (paths or links), including:
with the network flux split to multiple portions (flows or packets), categorizing each portion (a flow or a packet) to a number H of categories (subsets or subgroups);

according to the category each portion belongs, selecting one of a number H of connection sequences (path sequences or link sequences) for each portion; wherein each connection sequence is a permutation of a number K of tokens, each token is associated with a connection;

marking each token as valid or invalid according to whether the associated connection is active or inactive; and

for each portion, selecting one of the connections according to an order of the tokens in the selected connection sequence, e.g., selecting the connection associated with a token of a predetermined order, e.g., the highest order, among the valid tokens in the selected path sequence.

To sum up, the path selection mechanism according to the invention is advantageous by, e.g., effective suppression of number of disrupted flows when number of active paths varies, efficient disruption handling without necessity to reconstruct new mapping tables, and superior uniformity to distribute the traffic over the updated active paths after number of active paths varies.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for managing a network traffic by selecting one of a plurality of paths for a packet of the network traffic, comprising:
by a network device, selecting one of a plurality of path sequences for the packet; wherein each of the plurality of paths sequences is an orderly list of a same plurality of tokens, and the plurality of tokens are respectively associated with the plurality of paths; and
according to an order of the plurality of tokens in the selected path sequence, selecting one of the paths for the packet.

2. The method of claim 1, wherein selecting one of the paths for the packet comprises:
selecting the path that is associated with the highest ordered token in the selected path sequence.

3. The method of claim 1 further comprising:
when one of the paths is in a first status, marking the token associated with the active path as valid; and
when one of the paths is in a second status, marking the token associated with the inactive path as invalid.

4. The method of claim 3, wherein selecting one of the paths for the packet comprises:
selecting the path that is associated with the highest ordered token among the valid tokens in the selected path sequence.

5. The method of claim 1 further comprising:
for each of the plurality of tokens, providing a validness signal for recording whether each token is marked as valid or invalid.

6. The method of claim 1 further comprising:
categorizing the packet to one of a plurality of group indices, wherein the plurality of group indices are respectively associated with the plurality of path sequences; and
while selecting one of the path sequences for the packet, selecting the path sequence that is associated with the categorized group index of the packet.

7. The method of claim 6, wherein the packet is so categorized that the packet has substantially statistically equal probability to be categorized to any one of the group indices.

8. The method of claim 6 further comprising:
according to content of the packet, calculating a calculation index for the packet by the network device;
while categorizing the packet to one of the group indices, categorizing the packet to the group index that is equal to the calculation index of the packet.

9. The method of claim 1 further comprising:
permuting order of the plurality of tokens to provide the plurality of path sequences, such that each of the plurality of path sequences reflects a permutation of the plurality of tokens.

10. The method of claim 9, wherein the permuting is randomized based on Knuth permutation algorithm.

11. The method of claim 1, wherein each of the plurality of tokens has substantially statistically equal probability to be listed in any order of any one of the plurality path sequences.

12. A network device comprising:
an access block controlling a plurality of paths for cooperatively bearing a network traffic; and
a path selection block coupled to the access block,
wherein, the path selection block selects one of the paths for a packet of the network traffic according to one of a plurality of path sequences, each path sequence represents one of a plurality of permutations associated with a plurality of tokens, and the tokens are respectively associated with the paths.

13. The network device of claim 12, wherein the path selection block selects one of the paths for the packet according to an order of the plurality of tokens in one of the path sequences.

14. The network device of claim 12, wherein the path selection block selects the path that is associated with the highest ordered token in one of the path sequences.

15. The network device of claim 12 further comprising:
a validness block for:
when one of the paths is in a first status, marking the token associated with the active path as valid; and
when one of the paths is in a second status, marking the token associated with the inactive path as invalid.

16. The network device of claim 15, wherein the path selection block selects the path that is associated with the highest ordered token among the valid tokens in one of the path sequences.

17. The network device of claim 16, wherein the validness block is further arranged to:
for each of the plurality of tokens, set a validness signal for recording whether each token is marked as valid or invalid.

18. The network device of claim 12, wherein the path selection block is further arranged to
categorize the packet to one of a plurality of group indices, wherein the plurality of group indices are respectively associated with the plurality of permutations; and
while selecting one of the path for the packet according to one of the path sequences, select according to the path sequence which represents the permutation that is associated with the categorized group index of the packet.

19. The network device of claim 18, wherein the packet is so categorized that the packet has substantially statistically equal probability to be categorized to any one of the group indices.

20. The network device of claim 18, wherein the path selection block is further arranged to:
according to content of the packet, calculate a calculation index for the packet;
while categorizing the packet to one of the group indices, categorize the packet to the group index associated with the calculation index.

21. The network of claim 12 further comprising:
a permutation block for providing the plurality of permutations formed by permuting order of the plurality of tokens.

22. The network device of claim 21, wherein the permuting is randomized based on Knuth permutation algorithm.

23. The network device of claim 12, wherein each of the plurality of tokens has statistically equal probability to be listed in any order of any one of the permutations.
